(19) United States
(12) Patent Application Publication
(10) Pub. No.: US 2012/0006573 A1
(43) Pub. Date: Jan. 12, 2012

(54) OIL PULSE ROTARY TOOL

(75) Inventor: Manabu SUGIMOTO, Anjo-shi (JP)

(73) Assignee: MAKITA CORPORATION, ANJO-SHI (JP)

(21) Appl. No.: 13/152,897

(22) Filed: Jun. 3, 2011

(30) Foreign Application Priority Data
Jul. 7, 2010 (JP) 2010-154910

(51) Int. Cl. B25D 11/06

(52) U.S. Cl. 173/104

(57) ABSTRACT

An oil pulse rotary tool includes a motor, a speed reduction mechanism to which rotation is transmitted from the motor, and an oil pulse generator disposed in front of and coaxially with the speed reduction mechanism. The motor, the speed reduction mechanism, and the oil pulse generator are housed in a housing. A carrier portion is provided coaxially with the oil pulse generator to project from a rear portion of the oil pulse generator. Support shafts that support planetary gears provided in the speed reduction mechanism are fixed to the carrier portion. A bearing is provided between the planetary gears and the oil pulse generator to support the carrier portion.

### BACKGROUND OF THE INVENTION

This application claims the entire benefit of Japanese Patent Application Number 2010-154910 filed on Jul. 7, 2010, the entirety of which is incorporated by reference.

### TECHNICAL FIELD

The present invention relates to an oil pulse rotary tool that intermittently produces a large torque using an oil pulse generator.

### BACKGROUND ART

Japanese Patent Number 3382043 discloses an oil pulse impact tool with a reduced overall length in the axial direction. In the oil pulse impact tool according to Japanese Patent Number 3382043, an electric motor and a planetary mechanism are included in a first block, and an impact device is included in a second block. An end plate for a liner of the impact device also serves as a carrier that supports planetary gears. When both the blocks are coupled to each other and a shaft portion provided at the end plate is supported by a bearing, the planetary gears on the impact device side are inserted between an internal gear and a sun gear in the first block to mesh with the internal gear and the sun gear. Thus, a coupling portion for transmitting rotation between both the blocks is not interposed between both the blocks but disposed in the first block. In this way, the overall length of the oil pulse impact tool in the axial direction is reduced.

While oil pulse rotary tools represented by the above oil pulse impact tool are advantageous in having a reduced overall length in the axial direction of the tool, it has been desired in recent years to make the oil pulse rotary tools further more compact.

### SUMMARY OF THE INVENTION

The present invention has been proposed in view of such circumstances, and therefore has an object to provide an oil pulse rotary tool that can be made compact.

A first aspect of the present invention provides an oil pulse rotary tool including a housing, a motor, a speed reduction mechanism, an oil pulse generator, a carrier portion, and a bearing. The motor is housed in the housing. The speed reduction mechanism to which rotation is transmitted from the motor is housed in the housing. The oil pulse generator is housed in the housing and disposed in front of and coaxially with the speed reduction mechanism. The carrier portion is provided coaxially with the oil pulse generator to project from a rear portion of the oil pulse generator, and to which a support shaft that supports a planetary gear provided in the speed reduction mechanism is fixed. The bearing is provided between the planetary gear and the oil pulse generator to support the carrier portion.

According to the oil pulse rotary tool of the first aspect of the present invention, the oil pulse generator and the speed reduction mechanism can be directly coupled to each other by fixing the support shaft for the planetary gear provided in the speed reduction mechanism to the carrier portion of the oil pulse generator.

Further, the bearing which supports the carrier portion can be disposed between the planetary gear and the oil pulse generator. Thus, since the oil pulse generator and the speed reduction mechanism are directly coupled to each other and, in addition, it is not necessary to provide a space for arranging the bearing between the motor and the speed reduction mechanism, the length of the housing in the front-rear direction can be reduced. Accordingly, it is possible to make the oil pulse rotary tool which includes the housing compact.

### BRIEF DESCRIPTION OF THE DRAWINGS

FIG. 1 is a longitudinal cross-sectional view of an oil pulse driver according to an embodiment of the present invention; and

FIG. 2 is a cross-sectional view of the oil pulse driver.

### DETAILED DESCRIPTION OF THE PREFERRED EMBODIMENTS

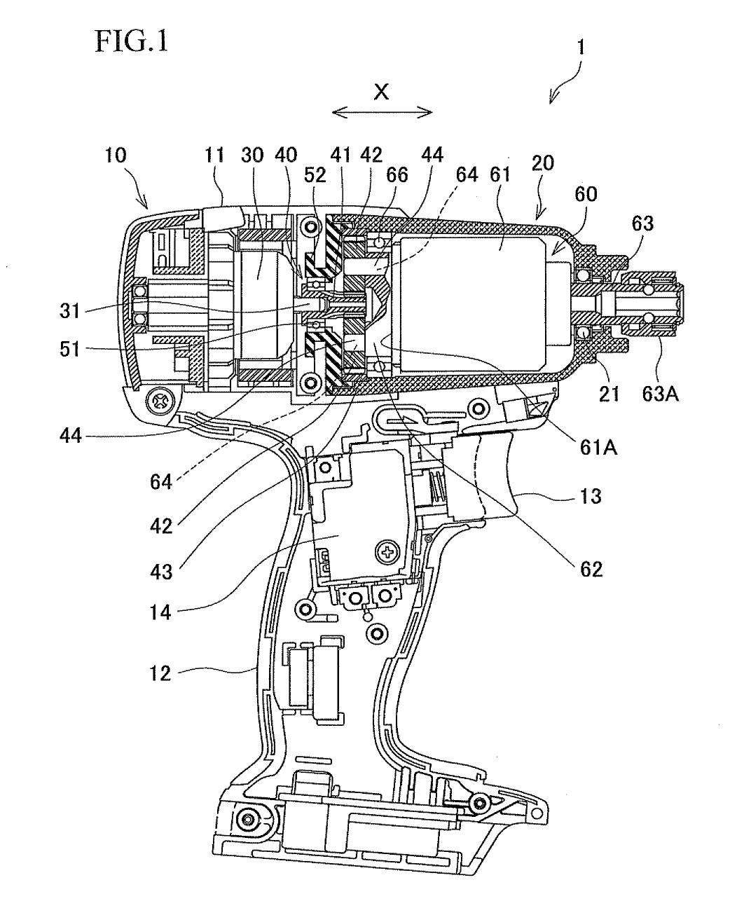

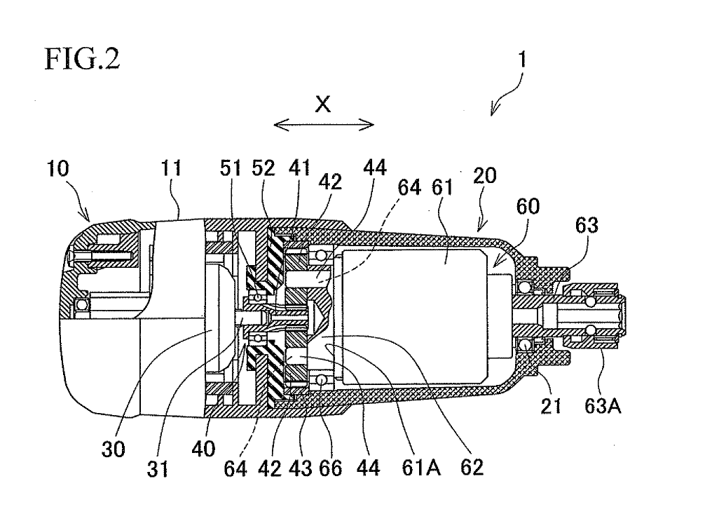

An embodiment of the present invention will be described with reference to FIGS. 1 and 2. An oil pulse driver 1 shown in FIGS. 1 and 2 includes a housing 10 and a unit case 20. The housing 10 is formed by assembling left and right half housings made of resin, and includes a body portion 11 and a handle portion 12. The body portion 11 is formed in a cylindrical shape to extend in the front-rear direction of the oil pulse driver 1 (in the left-right direction in FIGS. 1 and 2). A motor 30 and a planetary gear speed reduction mechanism 40 are housed inside the body portion 11. The oil pulse driver 1 is an example of the oil pulse rotary tool according to the present invention.

The motor 30 is disposed in the rear portion of the body portion 11 (on the left side in FIGS. 1 and 2). The planetary gear speed reduction mechanism 40 is disposed in front of the motor 30 in the body portion 11 (on the right side in FIGS. 1 and 2). The planetary gear speed reduction mechanism 40 includes a pinion 41, planetary gears 42, 42, and an internal gear 43.

The pinion 41 is secured to an output shaft 31 of the motor 30. The pinion 41 is rotatably journaled on a gear housing 52 through a ball bearing 51. The planetary gears 42, 42 are rotatably supported on a carrier portion 62 of an oil unit 60 through respective support shafts 44 to mesh with the pinion 41. The internal gear 43 is fixed in the gear housing 52 and the unit case 20 to mesh with the planetary gears 42, 42.

As shown in FIG. 1, the handle portion 12 is provided on the body portion 11 in a coupled manner to form substantially T-shape when the oil pulse driver 1 is viewed from a side surface. A switch 14 having a trigger 13 is housed inside the handle portion 12. Pulling the trigger 13 supplies electric power to the motor 30 to drive the motor 30.

The unit case 20 is disposed frontward of the gear housing 52 (on the right side in FIGS. 1 and 2) to be assembled in front of the body portion 11 (on the right side in FIGS. 1 and 2). The oil unit 60 is housed inside the unit case 20. With the unit case 20 positioned in front of the gear housing 52, the oil unit 60 is disposed frontward of and coaxially with the pinion 41 (planetary gear speed reduction mechanism 40), which is axially supported on the gear housing 52. The oil unit 60 is an example of the oil pulse generator according to the present invention. The housing 10 and the unit case 20 are an example of the housing according to the present invention.

The oil unit 60 includes a main body 61, the carrier portion 62, and a shaft 63. The carrier portion 62 is provided coaxially with the main body 61 to project from a rear end surface 61 A of the main body 61. Insertion holes 64, 64 for insertion of the support shafts 44, 44 are provided to open in a surface of the carrier portion 62 on the planetary gear speed reduction mechanism 40 side to be recessed in a front-rear direction X (see FIGS. 1 and 2) of the carrier portion 62. Since base portions of the support shafts 44 are press-fitted into and fixed to the insertion holes 64 respectively, the carrier portion 62 (oil unit 60) and the planetary gear speed reduction mechanism 40 can be directly coupled to each other. The rear end surface 61A is an example of the rear portion of the oil pulse generator according to the present invention.

The projecting length of the carrier portion 62 is set such that the press-fitted length of the support shafts 44 can be secured. A space corresponding to the projecting length of the carrier portion 62 is formed between the rear end surface 61 A and the planetary gears 42, 42 in the front-rear direction X and between an inner circumferential surface of the unit case 20 and an outer circumferential surface of the carrier portion 62. In the embodiment, since a ball bearing 66 is disposed in the space, the carrier portion 62 can be axially supported on an inner surface of the unit case 20 through the ball bearing 66. The ball bearing 66 is an example of the bearing according to the present invention.

The shaft 63 is provided coaxially with the main body 61 to project from a front end surface of the main body 61 through the unit case 20. The shaft 63 is rotatably supported on an inner surface of the unit case 20 through a ball bearing 21. A chuck 63A to which a bit can be mounted is provided at the distal end of the shaft 63.

Next, an operation of the oil pulse driver 1 according to the embodiment will be described. For example, when a user pulls the trigger 13 to drive the motor 30, rotation of the motor 30 is transmitted via the pinion 41 to the planetary gears 42, 42. The planetary gears 42, 42 mesh with the internal gear 43 to revolve around the outer periphery of the pinion 41 while rotating. Accordingly, the carrier portion 62 and the main body 61 rotate (here, rotate rightward when facing forward in the front-rear direction X), which rotates the bit mounted to the shaft 63 to enable screw tightening or the like. In the case where a thrust load (vibration) is intermittently applied to the carrier portion 62 during rotation of the carrier 62, the thrust load is absorbed by the ball bearing 66.

When the load on the shaft 63 is increased along with the progress of screw tightening work to delay rotation of the shaft 63 with respect to rotation of the carrier body 62 and the main body 61, the oil unit 60 produces an impact torque produced by a hydraulic pressure. The impact torque is intermittently applied to the shaft 63 to enable additional screw tightening.

In the oil pulse driver 1 according to the embodiment, the oil unit 60 and the planetary gear speed reduction mechanism 40 can be directly coupled to each other by press-fitting into and fixing to the carrier portion 62 of the oil unit 60 the respective support shafts 44 of the planetary gears 42, 42 provided in the planetary gear speed reduction mechanism 40.

Further, the ball bearing 66 rotatably supports the carrier portion 62, and is disposed to be inserted between the rear end surface 61A and the planetary gears 42, 42 in the front-rear direction X utilizing the space discussed above. Thus, since the oil unit 60 and the planetary gear speed reduction mechanism 40 are directly coupled to each other and, in addition, it is not necessary to provide a space for arranging the ball bearing 66 between the motor 30 and the planetary gear speed reduction mechanism 40, the length of the body portion 11 of the housing 10 in the front-rear direction (in the left-right direction in FIGS. 1 and 2) can be reduced. Accordingly, it is possible to make the oil pulse driver 1 which includes the body portion 11 compact.

The present invention is not limited to the embodiment discussed above, and part of the configuration of the embodiment may be modified appropriately without departing from the scope of the present invention. For example, in the embodiment discussed above, the support shafts 44 are press-fitted into and fixed to the carrier portion 62. However, the support shafts 44 may be inserted into the carrier portion 62, and may be prevented from loosening using setscrews, for example.

In the embodiment discussed above, the present invention is applied to the oil pulse driver 1. However, the present invention may be applied to an oil pulse wrench or the like.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. An oil pulse rotary tool comprising:
a housing;
a motor housed in the housing;
a speed reduction mechanism which is housed in the housing and to which rotation is transmitted from the motor;
an oil pulse generator housed in the housing and disposed coaxially with the speed reduction mechanism;
a carrier portion that is provided coaxially with the oil pulse generator to project from a rear portion of the oil pulse generator, and to which a support shaft that supports a planetary gear provided in the speed reduction mechanism is fixed; and
a bearing provided between the planetary gear and the oil pulse generator to support the carrier portion.

2. The oil pulse rotary tool according to claim 1, wherein
the carrier portion is formed with an insertion hole into which the support shaft is inserted so that the support shaft is press-fitted into and fixed to the insertion hole.

3. The oil pulse rotary tool according to claim 1, wherein
the bearing is disposed between the planetary gear and the oil pulse generator by inserting the bearing into a space between an inner surface of the housing and an outer surface of the carrier portion.

4. The oil pulse rotary tool according to claim 2, wherein
the bearing is disposed between the planetary gear and the oil pulse generator by inserting the bearing into a space between an inner surface of the housing and an outer surface of the carrier portion.

5. The oil pulse rotary tool according to claim 3, wherein
the bearing is a ball bearing.

6. The oil pulse rotary tool according to claim 4, wherein
the bearing is a ball bearing.
